(19) United States
(12) Patent Application Publication
(10) Pub. No.: US 2006/0129652 A1
(43) Pub. Date: Jun. 15, 2006

(54) System to coordinate the execution of a plurality of separate computer systems to effectuate a process (as amended in search report)

(76) Inventor: Anna Petrovskaya, Cupertino, CA (US)

Correspondence Address: MORRISON & FOERSTER LLP, 755 PAGE MILL RD, PALO ALTO, CA, 94304-1018, US

(21) Appl. No.: 11/351,616

(22) Filed: Feb. 10, 2006

Related U.S. Application Data
(63) Continuation of application No. 10/088,949, filed on Mar. 21, 2002.
(60) Provisional application No. 60/156,809, filed on Sep. 29, 1999.

(51) Int. Cl. G06F 15/16

(52) U.S. Cl. 709/208

(57) ABSTRACT

A system is provided to effectuate steps of a process such as a business process. A core system receives a request by a user to effectuate the process, along with user data upon which it is desired to effectuate the process. A coordinating system causes and coordinates execution of a plurality of target computer systems based on the indication of the action and user data, to accomplish effectuation of the process.

### RELATED APPLICATIONS

This application claims priority under 35 U.S.C. §119(e) to provisional patent application Ser. No. 60/156,809, filed Sep. 29, 1999.

### COPYRIGHT AUTHORIZATION

A portion of the disclosure of this patent application contains material subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present invention is in the field of development and maintenance of software solutions. More particularly, the invention relates to a tool that somewhat systematizes and automates the process of developing and maintaining such software solutions for execution on distributed computer systems.

### BACKGROUND

We live during exiting times of hi-tech revolution that deeply affects many aspects of our society. In particular it has changed how companies compete with one another. No matter what industry sector, today's competitive edge comes from mastering emerging technologies ahead of the rivals. For example, a restaurant's web page with a current menu gives a competitive advantage over other restaurants. In the software business, customers prefer companies that provide documentation, customer support and sales on-line. While the revolution has been triggered by new communication technologies (popularly known as “the Internet”), the rapid pace has been sustained by using software rather than hardware to implement many features of emerging technologies quickly and inexpensively. This rapid pace of technology creates an ever-changing environment. The environment is so dynamic that many times features designed into software at one point of time are no longer sufficient by the time the software gets to the market. Consequently, new technologies systematically come out without being fully accustomed to the environment in which they are to be used. However, competition is pushing many companies to make the best use of emerging technologies by integrating and extending them to the point where they provide full solutions. We call these solutions “in-house solutions” as they are developed inside of a company and customized for its own use. We shall distinguish in-house solutions from commercial solutions that are made for sale.

In-house solutions may be built to implement business methods or to improve operations. Business method in-house solutions implement entire business methods such as selling books online, recording CDs to customer order or providing Internet services to clients. While not every business method can be implemented by an in-house solution, many businesses employ in-house solutions to improve internal or external operations. Internally focused in-house solutions implement employee or equipment related processes. For example, an internally focused in-house solution may implement an “incoming process” used by companies whenever they hire a new employee. Externally focused in-house solutions implement processes targeted at clients, suppliers or partners. While business method in-house solutions enable new types of businesses to function, operations oriented in-house solutions cut costs and delays by streamlining operations. For over a decade, in-house solutions have been enabling companies to survive and compete in today's hi-tech revolution conditions.

Conventional tools for implementing “in-house solutions” are now discussed. On the low technical level, in-house development and maintenance are very similar to their commercial counterparts. Consequently, in-house developers and administrators have traditionally used generic tools such as languages, compilers, libraries, version control applications, bug tracking systems and others. However, as it is discussed in greater detail below, there are some important differences between in-house and commercial solutions. Because of these differences, enterprises developing and maintaining in-house solutions have needs that have not been addressed for over a decade.

Let us list and briefly explain some of the problems that arise from the fact that in-house solutions are not made for a large commercial market. First, the financial gains from developing such software are significantly lower. While millions of copies of commercial software could be sold for $100 or more per copy, in-house solutions are considered a success if they save a few million dollars over their lifetime. Thus funding available for in-house solutions is under 1% of funding available for commercial software. Consequently, enterprises can not afford to keep permanent development and support teams working on in-house solutions. Instead, they gather expertise from all over the enterprise for a short period to develop the solution. The support is done on demand by administrators of the solution. While this tactic saves money, it also results in a multitude of problems that we will summarize below.

Since development team does not exist as a stand-alone group, immediate concerns prevail over long-term needs during development cycle. Infrastructure work (such as architecture and documentation) gives way to specific convenience features. Little assessment and plans are made for how solution will evolve with changing needs of enterprise. Since members of the team come from different groups and do not work on the project full-time, they bring with themselves priorities and schedules that come from their other projects. This leads to longer development cycles, because the whole team moves at the pace of its slowest member at any given point in time.

In contrast to a commercial development environment, there is no dedicated technical writer to write proper documentation and to keep track of changes made to software over time. Therefore, in-house solutions are usually poorly or not at all documented. Furthermore, unlike in commercial development, there are no dedicated Quality Assurance engineers. Thus, Quality Assurance is not performed at all or performed by engineers who have little knowledge of the product they are testing. Consequently, very few bugs are discovered prior to the product going live.

In commercial development, the development team is kept intact after the first version of solution goes live. Moreover, the development team trains additional resources to help maintain and support the solution. In contrast, the in-house development team is disbanded after the solution goes live. Improvements and bug fixes of in-house solutions are usually done sporadically by new developers. There is no guarantee that developers extending a solution participated in its initial development. Therefore, no expertise is passed on from the original development team to developers who end up maintaining the solution. This is especially harmful to the quality of the solution because there is no up-to-date documentation. Consequently, expertise and code are not reused during extensions of a solution.

Since many new technologies are integrated in an in-house solution, it is virtually impossible to find an administrator who is experienced in working with all of the technologies involved. Furthermore, administrators who support in-house solutions receive no training and are given no documentation to train themselves. Consequently, not only does it take a long time to debug and fix problems, but also new problems are often introduced via patches made by administrators with little knowledge of the system.

Another drawback of in-house solutions is that they get very little exposure to a technical audience. Since millions of copies of commercial software are typically sold, millions of technical teams comprised of developers and administrators learn about the software as well as install and test it for their own use. This fact is well known to IT departments, who like to let new software float on the market for a few months before installing it on their own systems. Many bugs are usually discovered within the first few months of new software being on the market and developers create jumbo patches that are distributed to customers. In contrast, in-house solutions only enjoy the audience of one development team and a few administrators who maintain the system later. Thus, bugs inherent in the solution may not be discovered until after they have caused extensive damage. While bugs contribute to overall low quality of software, it is in the system security area where bugs may be the most harmful. This is because one small security bug can invalidate the security of the whole system. While commercial solutions enjoy the benefits of collective efforts to discover security bugs and prevent break-ins, security of an in-house solution is left to a small team of developers.

A major purpose of in-house development is to integrate available technologies into a solution that closely fits the needs of the enterprise. As we mentioned earlier, the rapid pace of technology creates an ever-changing environment. Therefore, to stay effective, an in-house solution should evolve dynamically with the changing needs of the enterprise. Unfortunately poor architecture, missing documentation and absent training make extending in-house solutions a slow, error-prone and inefficient process. Since measuring the cost of inefficiency and low quality is a difficult task, let us turn to an example where they translated into some very visible numbers. On Jun. 10^{th} of 1999 a twenty two-hour outage of eBay's website was followed by a $2 billion drop in the company's market value. The cause of the outage was determined to be an attempt to add new features to an existing in-house system.

To summarize, it is desired that today's enterprise be able to efficiently develop and maintain in-house solutions that are comparable in quality, reliability and security to commercial solutions; that are subject to all the limiting factors imposed on in-house solutions; and that dynamically adapt to changes in enterprise's needs.

### SUMMARY

In accordance with the invention, a system is provided to effectuate steps of a process such as a business process. A core system receives a request by a user to effectuate the process, along with user data upon which it is desired to effectuate the process. A coordinating system causes and coordinates execution of a plurality of target computer system based on the indication of the action and user data, to accomplish effectuation of the process.

### BRIEF DESCRIPTION OF FIGURES

FIG. 1 is a schematic illustration of the environment in which the invention operates.

FIG. 2 illustrates an embodiment in accordance with the invention.

FIG. 3 illustrates a particular detailed implementation of the FIG. 2 embodiment.

FIG. 4 illustrates the FIG. 3 implementation in greater detail.

FIG. 5 illustrates a tree data model usable in accordance with an embodiment of the invention.

FIG. 6 illustrates an example of a specific tree structure.

FIGS. 7 and 8 illustrate a method by which an ENGINE processes a Request.

### DETAILED DESCRIPTION

We now describe in detail several embodiments in accordance with the invention. The description includes a source code listing included herein as Appendix A. We use italicized words to denote elements of our data model and CAPITALIZED words to denote external components, components of our system and subjects. We use typewriter font to denote machine commands, data, file and directory names. In referring to our source code, we will use relative and absolute pathnames. By default, relative pathnames will be relative to /share/kiki/WF/prod directory.

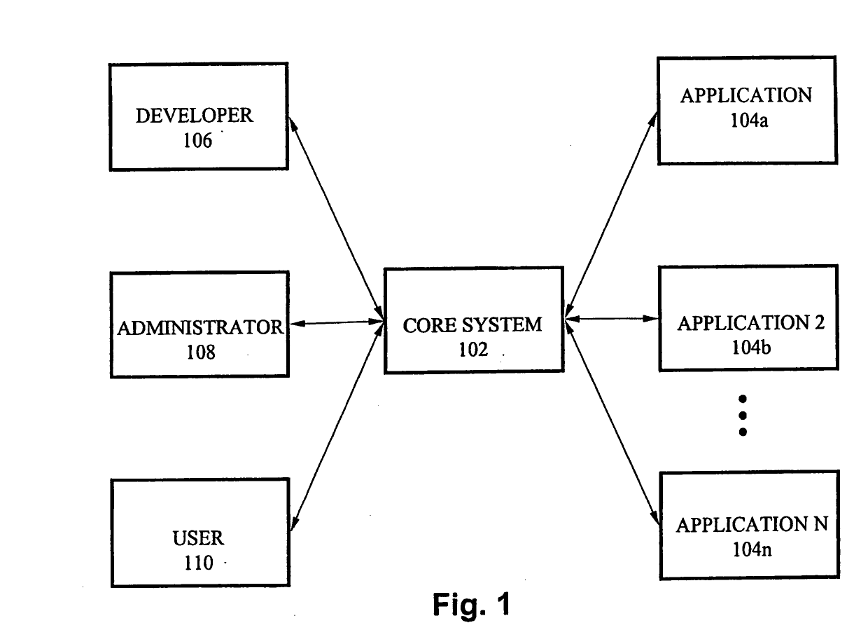

A schematic representation of our system is depicted in FIG. 1. The box labeled CORE SYSTEM 102 represents the core of the embodiment. Boxes labeled APPLICATION 1 (104a) through APPLICATION N (104n) represent existing applications employed in an enterprise. Boxes labeled DEVELOPER 106, ADMINISTRATOR 108 and USER 110 represent an in-house solution developer, an in-house solution administrator and an in-house solution user respectively. Arrows represent directions of data flows.

To create an in-house solution, DEVELOPER 106 interacts with CORE SYSTEM 102 to define an Action. An Action is a definition of an in-house solution. It contains information as to which APPLICATIONS 104 are to be involved and what data needs to be collected from USER 110 and passed to APPLICATIONS 104, as well as rules for execution. To use the in-house solution created by DEVELOPER 106, USER 110 interacts with CORE SYSTEM 102 and places a Request to run the Action. Request contains data passed by USER 110 and a reference to the Action. When a Request has been placed, CORE SYSTEM 102 interacts with APPLICATIONS 1 through N (104a through 104n) specified in Action and passes USER 110 data from the Request to APPLICATIONS 104 following rules defined in the Action. ADMINISTRATOR 108 interacts with CORE SYSTEM 102 to monitor execution of the Request, diagnose and troubleshoot problems if they arise. Action and Request are part of our data model that is discussed in more detail later in this Detailed Description.

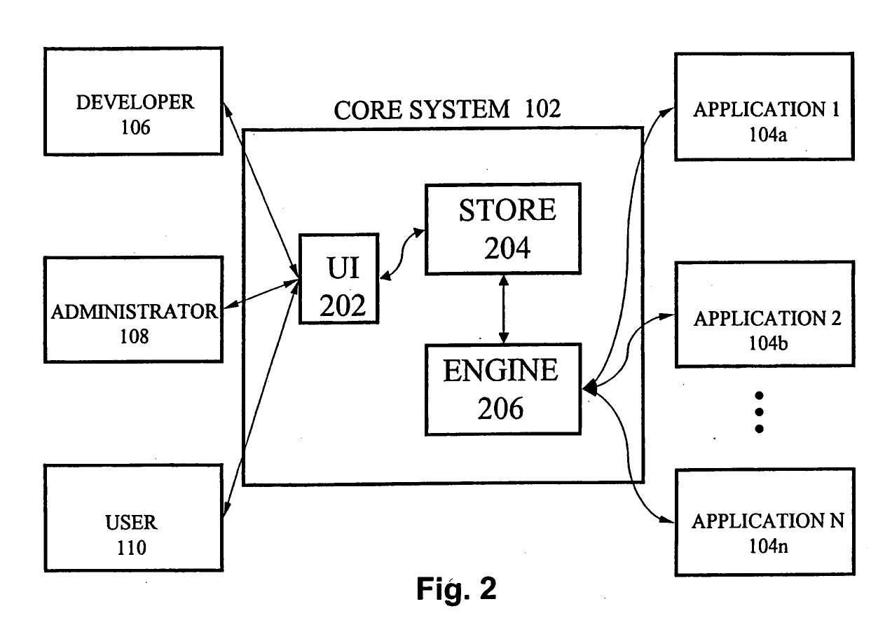

Let us look at CORE SYSTEM 102 in more detail (see FIG. 2). We identify the following components of CORE SYSTEM 102: user interface (UI) 202, data store (STORE) 204 and engine (ENGINE) 206. UI 202 enables exchange of information between DEVELOPER 106, ADMINISTRATOR 108 or USER 110 on one hand and STORE 204 on the other hand. STORE 204 is used to hold Actions, Requests, execution data, logs, ENGINE 206 state information, and other data necessary for the system to function. ENGINE 206 monitors STORE 204 for new Action definitions created by DEVELOPER 106 and new Requests posted by USER 110. When ENGINE 206 receives a Request, it verifies its consistency with the corresponding Action definition. ENGINE 206 then passes USER 110 data from the Request to APPLICATIONS 104 according to rules specified in the Action. ENGINE 206 monitors communications with APPLICATIONS 104 and receives updates on completion of operations from APPLICATIONS 104. ENGINE 206 stores all execution data received from APPLICATIONS 104 in STORE 204. ADMINISTRATORS 108 can view the execution details via UI 202.

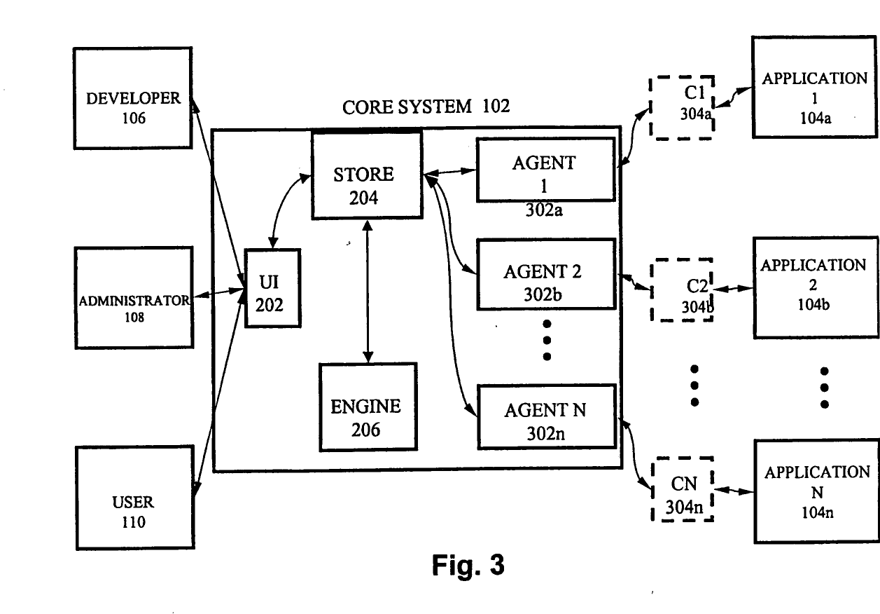

We have discussed the implementation of the general model. FIG. 3 illustrates a refined embodiment. In particular, the refinement is a mechanism of communication between ENGINE 206 and APPLICATIONS 104. When ENGINE 206 needs to pass data to an APPLICATION 104 it creates a Job Order containing the data and places it in STORE 204. The boxes labeled AGENT 1 (302a) through AGENT N (302n) represent components of our system that correspond to APPLICATIONS 1 (104a) through N (104n). An AGENT 302 has the responsibility of picking up Job Orders for its APPLICATION 104 from STORE 204, passing the data contained in the Job Order to the APPLICATION 104, monitoring execution, and recording results of operations in STORE 204. After an AGENT 302 updates a Job Order with execution details it received from its APPLICATION 104, ENGINE 206 picks up the Job Order, determines whether operation performed by the APPLICATION 104 was successful, and continues working according to the rules defined in the Action.

The AGENTS 302 communicate with APPLICATIONS 104 through an operating system. During Action creation DEVELOPER 106 specifies a special string (command) for each APPLICATION 104. ENGINE 206 retrieves the command, makes substitutions of portions of the string for USER 110 data and stores the resulting command in Job Order together with USER 110 data. AGENT 102 retrieves the command from Job Order and presents it to operating system for execution.

It may not always be possible or convenient to record the whole operation to be performed by APPLICATION 104 in one command string. In such cases DEVELOPER 106 has the option of creating a custom executable, containing the full operation to be performed by the APPLICATION 104. Boxes labeled C1 (304a) through CN (304n) in FIG. 3 represent these custom executables. The command then becomes a simpler string that calls the custom executable. Although there is no restriction on the complexity of the custom executables, we expect them to usually be simple scripts. Development of the custom executables is simplified due to a number of factors. First of all, the AGENT 102 typically runs on the same machine as the custom executable and (usually) the APPLICATION 104, thus there is no need for communications over network. (Of course, in its broadest aspect, the invention is not so limited.) The custom executable can be written in any language of DEVELOPER's (106) choosing, and thus could be native to the APPLICATION 104 and the operating system environment. Finally, the AGENT 104 makes user data readily available to the custom executable. We support several ways of passing data: as part of command string, on standard input and via environment variables.

We now discuss an overview of a detailed implementation. We used Directory Server as STORE 204. Throughout this document we use the terms Directory Server, LDAP server and LDAPSVR interchangeably to mean Directory Server. Directory Servers are produced by many commercial and non-commercial organizations (e.g. Netscape Corp. and University of Michigan). Additional information about Directory Servers and the protocols used to communicate with them (LDAP and LDAPS) can be found in RFCs 1777 and 2251 at http://www.cis.ohio-state.edu/hypertext/information/rfc.html as well as documentation provided by manufacturers of Directory Servers. We used Netscape LDAP SDK library for communication with Directory Server. Documentation on LDAP SDK is available from Netscape. We used a collection of web pages and CGI scripts as UI 202. Users (DEVELOPER 106, ADMINISTRATOR 108 and USER 110) of the system can access UI 202 via a web browser (404, 406 and 408, respectively. The code for most components is written in C++. To compile the C++ code we used GNU egcs compiler produced by Free Software Foundation. Portions of code for UI are written in Perl5, Bourne Shell, HTML and C++.

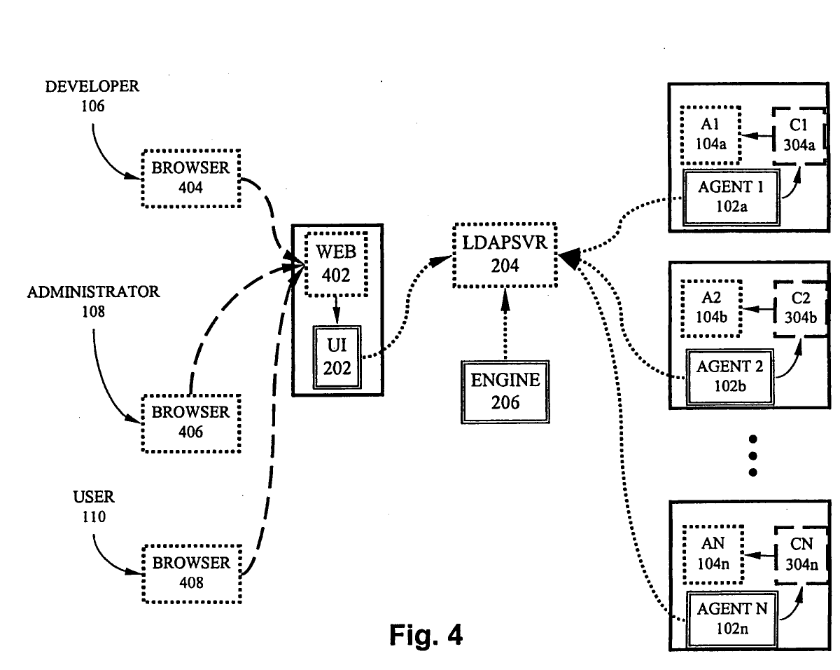

FIG. 4 is a schematic representation of our detailed implementation. Boxes with solid borders represent physical machines. Boxes with double borders represent software components developed as part of our system. Boxes with dotted border are either standard third party applications or pre-existing applications. Boxes labeled A1 through AN denote APPLICATION 1 (104a) through APPLICATION N (104n). Boxes with dashed borders are optional components developed by DEVELOPER 106. Arrows in the diagram represent connections (network or other). Arrows are drawn in the direction in which the connection is initiated. Dotted arrows represent connections made via LDAP or LDAPS protocols. Dashed arrows represent connections made via HTTP or HTTPS protocols. Thus all network connections in our system are made via standard protocols with secure counterparts. Our implementation includes the following components: ENGINE 206, AGENT 102, LIBRARY (which is common to every component as described in greater detail below). and UI 202.

We will describe each component in more detail below, however, first let us turn to the data model we used in our implementation. We define the following classes of objects for storage: CPAT, ParamW, User, Group, Engine, Agent, Action, Job, Request, Job Order and Folder. Each of the classes has a corresponding class defined in our C++ code and in LDAPSVR schema. Throughout this description, we use the same italicized object class names to also mean objects of the class as well as the general notions the objects are intended to represent. CPAT is the parent of all the other classes we store in LDAPSVR and has the standard class top as its parent. We do not use objects belonging to class CPAT directly, but rather use the class as a virtual parent class. CPAT has a field name that is stored in attribute cn. We use names as user-friendly object identifiers that are suggestive of the object's function. We store all of our objects in the same tree in LDAPSVR. The top of our tree is a Folder called TOP. Folders are used to organize data inside of our tree in LDAPSVR into subtrees. Users are given an interface to build arbitrary trees of Folders. Objects of classes Engine, ParamW, Agent, Action and Job can be stored anywhere inside of our tree. For convenience we impose additional structure on our tree. Directly underneath Folder TOP, we create Folders users, Groups, Collections and System. Folders users and Groups contain objects of type Users and Groups respectively. Folder system contains system information. Folder collections contains user defined Folders, also called Collections. User defined objects go inside of Collections.

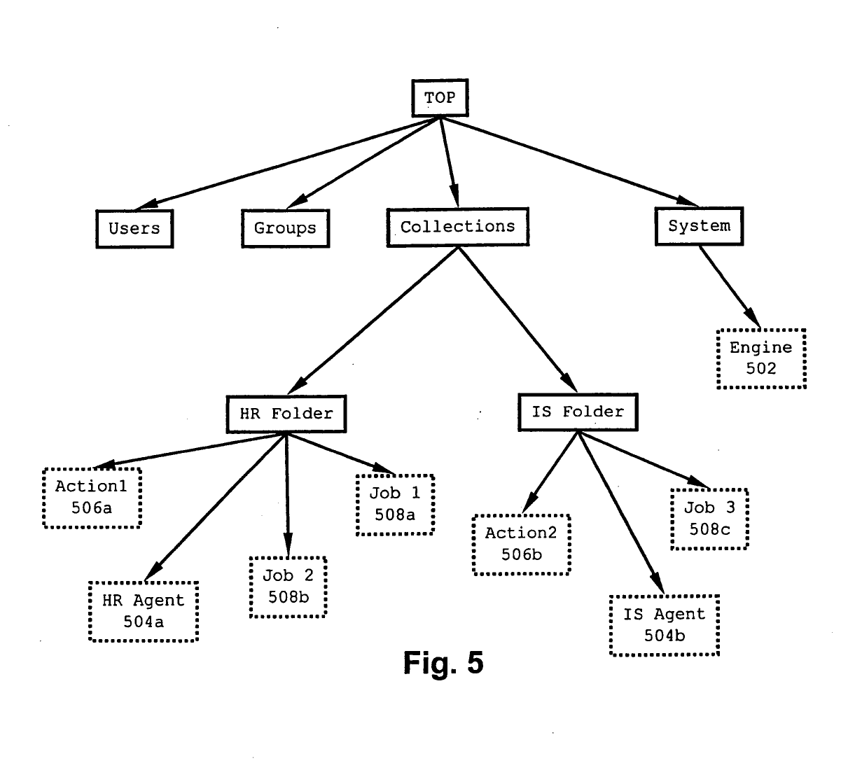

See FIG. 5 for an example of a tree. In this figure boxes with solid border denote Folders and boxes with dotted border denote other objects. An object of class Engine (e.g., the object labeled 502) stores configuration information for an ENGINE 206. An object of class Agent (e.g., the objects labeled 504a and 504b) stores configuration information for an AGENT 102. An object of class Action (e.g., the objects labeled 506a and 506b) stores an Action definition as described above. Action has a field script that holds a list of DNs of Jobs to be executed with some additional syntax. (DN stands for Distinguished Name, a unique identifier of a record in an LDAP database. See your Directory Server documentation or RFCs for more information on DNs.)

Field paramDN of Action stores a list of DNs of ParamWs. An object of class ParamW is a definition of a parameter, and contains information on how to present it to USER, default and allowed values as well as syntax rules. An object of class Job (e.g., the objects labeled 508a, 508b and 508c) stores data needed to interact with a specific APPLICATION. Job has a field param that stores a list of parameters needed to execute the Job, and a field rval that stores a list of parameters that the Job will return. Job also has a pointer to the Agent that is to execute the Job and a field command that stores the command as described above. Job has a field notify that contains the email addresses of developers/maintainers of the Job who will be notified if this Job fails. An object of class Request stores Request as described above. A Request is an instance of an Action execution. Requests inherit names from corresponding Actions. Request also contains a field submitterDN, which identifies the USER who submitted the Request. An object of class Job Order stores Job Order as described above. A Job Order is an instance of a Job execution. Job Orders inherit names from Jobs. Job Orders also contains a field start_time that stores the timestamp of beginning of execution. ENGINE 206 uses this field to monitor how long the Job Order takes to complete.

Our implementation includes four components: ENGINE, AGENT, UI and LIBRARY.

LIBRARY compiles into libutil.a, a library that contains procedures used by code in other components. Source code for LIBRARY is located in directory util.

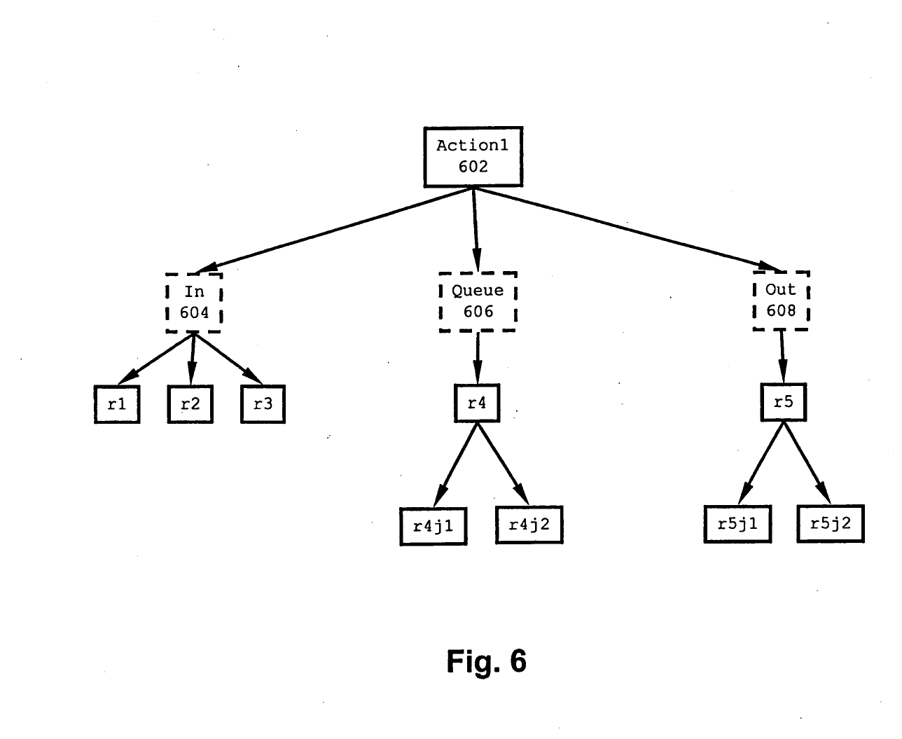

Source code for ENGINE is located in directory engine. Below is an outline of the component. Please refer to the source code for details. ENGINE is intended to run as a daemon. It reads its configuration files and then proceeds to main loop. ServiceDN configuration parameter stores the DN of the tree in which ENGINE works. This would normally be TOP. ENGINE searches in its working tree for objects of type Action and creates a list of all Actions that need to be serviced. It then services each Action on the list. After each Action has been serviced, ENGINE sleeps for a specified interval of time before proceeding to the next iteration of the main loop. ENGINE expects to find a specific tree structure underneath an Action. An example of such structure is depicted in FIG. 6.

Each Action 602 has three Folders underneath it: In 604, Queue 606, and out 608. Folder In contains new Requests posted by USER. Folder Queue is where Requests reside while being executed. Folder out is for Requests that have been executed (completed or failed). To service an Action, ENGINE first processes its In Folder. ENGINE reads the definition of the Action and all Jobs mentioned in the script. It then parses each Request and checks that USER supplied all necessary parameters. ENGINE moves the parsed Request into Queue and creates Job Order objects underneath it. ENGINE creates one Job Order per each Job mentioned in the script. Job Orders get IDs made up of the Request ID with Job sequence number appended. Job sequence numbers come from numbering all Job references in the script in the order they appear. Each Job Order contains enough information for an AGENT to be able to execute it. It includes command, Job definition data and USER data from the Request.

Each Request has a status field that is used by ENGINE. When ENGINE first puts the Request into Queue, it gives it status of HOLD to indicate that it has not completed parsing it yet. After all Job Orders are created underneath the Request, ENGINE changes the Request's status to RUNNABLE. Each Job Order also has a field status that is used by ENGINE and AGENTS. ENGINE first creates a Job Order with a status of HOLD.

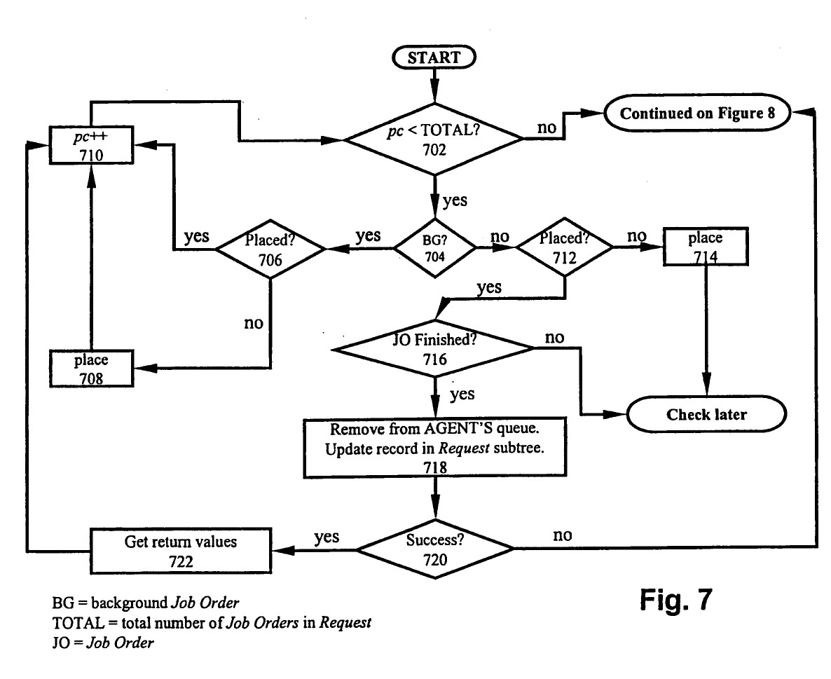

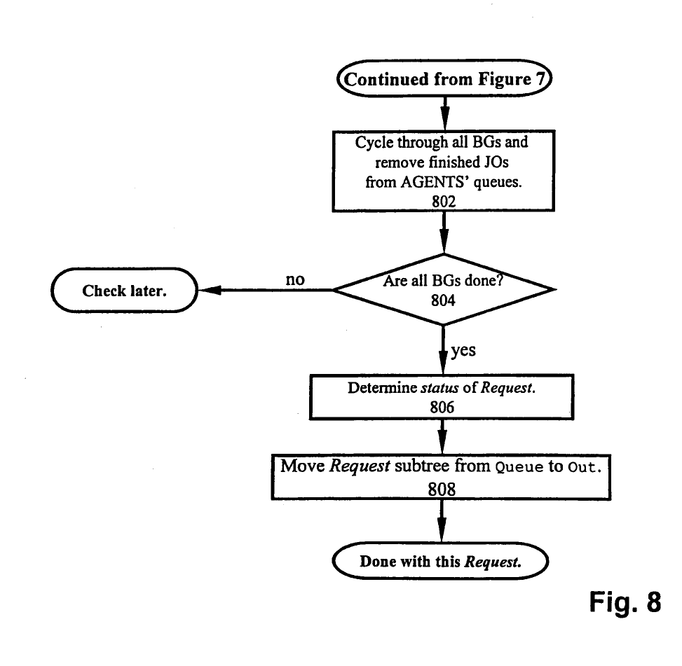

After processing Folder In of each Action on the list, ENGINE moves on to process Folder Queue. For each Action it retrieves all Requests in Queue and processes them one by one. With reference to FIGS. 7 and 8, we describe what ENGINE does with each Request. We also refer to the source code in file engine/EngineD.cc (especially procedures EngineD::state_machine and EngineD::wait_for_bg_jobs). Each Request has a field pc that holds the sequence number of the Job Order currently being executed. If pc is less than the total number of Job Orders in the Request (step 702), the ENGINE checks the Job Order pointed to by pc (see FIG. 7).

If the Job Order is a background Job Order (step 704), the ENGINE checks to see whether it has been placed (step 706). If the Job Order has not been placed, the ENGINE places the Job Order (step 708) before proceeding. The ENGINE then increases pc by one (step 710) and moves on to the next Job Order.

If the Job Order is a foreground Job Order, the ENGINE checks to see whether it has been placed (step 712). If the Job Order has not been placed, the ENGINE places the Job Order (step 714) and moves on to work on other Requests. If the Job Order has been placed before, the ENGINE checks the AGENT's queue to see if the Job Order has been completed (step 716). If not, the ENGINE moves on to the next Request. If yes, the ENGINE removes the Job Order from the AGENT's queue (step 718), determines whether the Job Order has succeeded or failed (step 720) and updates the Job Order record in the Request's subtree. If the Job Order was successful, the ENGINE pulls return values from the Job Order (step 722) and stores them in the Request. The ENGINE then increases pc (step 710) and moves on to the next Job Order.

If the Job Order has failed or there are no more Job Orders to process for this Request, the ENGINE waits for all background Job Orders (see FIG. 8). To do this, the ENGINE cycles through all background Job Orders (step 802) and removes completed ones from AGENTS' queues. If it encounters any background Job Orders that have not yet finished execution (step 804), ENGINE moves on to process other Requests. If all background Job Orders have finished, ENGINE determines the status of the Request (step 806). If all Job Orders in the Request have completed successfully the status of the Request is COMPLETE, otherwise the status is ERROR. Lastly, the ENGINE moves the whole Request subtree from Folder Queue to Folder Out (step 808) and goes on to do other work.

To place a Job Order, ENGINE first determines values of all parameters needed by the Job Order. ENGINE takes Request's parameter values and assigns them to the Job Order parameters taking into account parameter mappings defined in the script. Parameter mappings allow a Job Order parameter value to be an arbitrary string with references to Request's parameters. For example, suppose Request has parameter x, Job Order has parameter y, and parameter mappings in script specify that y=“%<x> number”. Then if x has value of “telephone”, y will get value of “telephone number”. In this example %<x> is a reference to parameter x. If there is no parameter mapping defined for a parameter, its value is set to be the value of identically named Request parameter. After ENGINE determines values of all Job Order parameters, it makes substitutions of parameter references for Job Order parameter values in command string and standard input data (input). Finally, ENGINE writes the Job Order in AGENT's queue with status of RUNNABLE.

To pull return values (rvals) from a Job Order, ENGINE consults reverse parameter mapping definitions specified in script. Reverse parameter mappings follow the same conventions as ordinary parameter mappings we described in the previous paragraph. Reverse parameter mappings define Request's parameter values via arbitrary strings with references to Job Order return parameters. If a Request's parameter is not explicitly mentioned in reverse parameter mappings its value is not affected even if there is an identically named Job Order return parameter.

Source code for AGENT is located in directory agent. AGENT is intended to run as a daemon. It reads its configuration files and goes into main loop. ServiceDN configuration parameter tells AGENT where its record is in LDAPSVR. AGENT expects ENGINE to place all Job Orders for AGENT right underneath AGENT's record in LDAPSVR. AGENT retrieves all Job Orders in its queue with status RUNNABLE. It then services the Job Orders one by one. To service a Job Order AGENT forks off a child process (CHILD) and waits for it. CHILD prepares the environment and executes the command. Standard input, standard output, and standard error streams of CHILD are all connected to the AGENT. Besides the standard streams we also create an RVALS stream for passing return values from CHILD to AGENT. CHILD can access RVALS stream on file descriptor 3. The format of return values is one name-value pair per line with equality sign separating name from value. While waiting for CHILD to complete AGENT receives and appends to Job Order log all messages written by CHILD to standard output and standard error streams. AGENT also supplies input data to CHILD via the standard input stream and receives return values via RVALS stream. AGENT has time limitations on how long to let CHILD run. If CHILD does not exit on its own within the specified time period, AGENT will first send it a SIGTERM and then a SIGKILL signals causing CHILD to abort execution. No matter what caused CHILD to exit, AGENT gets and parses CHILD's exit status and appends its findings to the Job Order log. If CHILD exited with status 0, AGENT sets the Job Order status to COMPLETE. Otherwise AGENT considers that the execution failed and sets the Job Order status to ERROR. AGENT updates the Job Order record in LDAPSVR with the new status, log and rvals received from CHILD. AGENT then moves on to service the next Job Order.

UI includes of two subcomponents: CUI and CGIUI. The source code for CUI is located in directory ui and compiles into four executables: get_obj, move_obj, update_obj and run_action. The executables provide a low-level interface for manipulating objects in LDAPSVR and posting Requests, and can be used to batch up operations in a script or to perform operations from languages that support system calls (e.g. C or Java). The get_obj executable retrieves objects from LDAPSVR and prints them to standard output in URL-encoded form. The move_obj executable moves an object in LDAPSVR or removes an object from LDAPSVR. The executable takes an argument cmd that can have two values: del and move. If the value of the argument is del, the executable deletes an object from LDAPSVR. If the value of the argument is move, the executable moves an object in LDAPSVR. The update_obj executable makes changes to an existing LDAPSVR object or creates a new LDAPSVR object. The run_action executable posts new Requests in LDAPSVR. It retrieves Action object from LDAPSVR and verifies that USER has supplied sufficient data for a Request. It then generates a new Request ID and creates a new Request object. It posts the new Request into In Folder in the Action's subtree in LDAPSVR. To ensure uniqueness of the Request ID, run_action constructs it out of a timestamp, machine ID and process ID. This construction also allows to search Requests based on the time of posting or what machine they were posted from. Run_action prints the new Request to standard output in URL-encoded form. In case an error is detected during execution, all four executables in CUI output the error on standard error stream.

CGIUI component is written in Perl and Bourne Shell. There are three Bourne Shell scripts: console, admin and edit_object. They are located in cgi-bin directory of the web server. All of these scripts are simple wrappers of identically named Perl scripts. Bourne Shell scripts are used to set up environment for the corresponding Perl scripts. Refer to source code for more details on the Bourne Shell scripts.

The Perl code for CGIUI is located in perl directory and consists of a Perl module CPAT.pm, its submodules and three Perl CGI scripts: edit_object, console and admin. The Perl modules are used by the Perl scripts. Perl modules also provide a convenient API to our system for developers writing in Perl. The script console was made with the non-technical user (USER) in mind.

Therefore the web pages it creates typically have little technical detail in them so as not to overwhelm USER. The console script is for executing Actions and monitoring their progress. The Main Page shows all Actions USER is authorized to run categorized by collections, and various ways for USER to check on existing Requests. When USER selects an Action from the list, based on the information stored in the Action and all of its ParamWs the script creates Run Action Page for USER. Also if DEVELOPER has specified an address of a custom Run Action Page in form URL attribute of the Action, the script will redirect BROWSER to the custom Run Action Page. The Run Action Page queries USER for all necessary parameters that are needed to execute the Action. When USER presses Run Action Button on the page the script does syntax checks on parameter values and assuming all is well attempts to post a new Request to LDAPSVR. Upon successful completion the script displays Successful Completion Page letting USER know what the ID is for the new Request. If USER attempts to submit Run Action Page with invalid values of parameters, console displays the Run Action Page again, but with error message at the top, letting USER know what needs to be corrected. If there were any errors during submission of Run Action Page, the script displays Error Page letting USER know what the error was and what parameters USER submitted. On the Main Page, USER is also given the capability to search Requests based on portion of Request ID, any parameter value or submission time. If USER uses the search capabilities, the script searches LDAPSVR based on the search options selected by USER and displays Search Results Page. Search Results Page displays results of the search as a numbered list. Each list entry includes the object's name, ID, status and DN. Status fields are color-coded so it is easy to see which Requests or Job Orders have been completed, which ones are still running, and which ones have failed. By pressing on the Number Button of each list entry, USER can get detailed information about the Request. A detailed Request Page displays the Request's ID, name, status, log, DN, pc, parameters, subbmitterDN and a numbered list of Job Orders together with their names and statuses. USER can view Job order Page by pressing the Number on the Request Page. Job order Page displays the Job Order's ID, name, status, log, parameters, start_time, notify, return values, DN and Request's DN. Job order Page also displays a view Request Button that allows USER to view Request Page of the parent Request. The Main Page gives USER additional utility functionality, such as log out, browse help files, check user identity and create custom reports.

The script admin was made for DEVELOPERS and ADMINISTRATORS. The Main Admin Page displayed by the script allows ADMINISTRATORS to configure the application, create and manage users of the application, create and manage groups, manage user and group privileges. Also, for debugging purposes, admin gives a more advanced interface to browsing Requests and Job Orders. Main Admin Page also links to edit_object script for direct interaction with objects stored in LDAPSVR.

The script edit_object was made with the advanced technical user in mind. It would normally be used by DEVELOPERS and ADMINISTRATORS. Users can view, create and modify objects using this script. The objects that can be manipulated by this script are Actions, Jobs, Param Ws, Agents, Engines and Folders. The Front Page allows multiple search options for retrieving objects that users would like to edit. To create a new object the user has to specify a new Base DN that does not conflict with any other DN in LDAPSVR. To create a new object, the user has to press the New Button. To edit an existing object, the user has to press the Edit Button. Whether user is creating a new object or editing an existing one, the page that comes up is Edit Page. In case of a new object all fields in the Edit Page are left blank. In case of an existing object, the fields are populated with values from LDAPSVR. On the Edit Page, user can change the values of object's fields. Generally user is provided with three buttons on an Edit Page: Commit object Button, Revert object Button and update View Button. Commit Object Button writes the changes to LDAPSVR. Revert object Button reverts the fields to the values they have in LDAPSVR. Update View Button checks consistency of the object and reports any problems to the user without writing to LDAPSVR or erasing changes made by user. In case the object is an Action, user is provided with a search capability for retrieving Jobs he would like to add to the script. User can also change the order of Jobs in the script, specify how Action parameters are mapped to Job parameters (via parameter mappings) and where the Job's return values would be stored in the Action parameters (via reverse parameter mappings). Users are also given the capability to search and insert ParamW objects into Action definition.

It is now discussed how to produce a particular implementation. Choose a Solaris 2.6 SPARC machine to be your build machine. Copy the source code into an identical directory structure on the build machine. Unpack Netscape LDAP SDK in directory/share/Depot/ldapsdk-30-SOLARIS-export-ssl on the build machine. Run make in the top-level directory (/share/kiki/WF/prod). Use GNU make version 3.75, GNU egcs compiler version 2.91.57 and Netscape LDAP SDK version 3.0.

Install a Directory Server (Netscape, University of Michigan, or similar) on a machine. Configure the Directory Server to recognize suffix of o=NONE. Add schema rules to the Directory Server. Schema rules are contained in Schema directory. File attributes contains our definitions of attributes. File classes contains our definitions of object classes. Start the Directory Server. Add contents of LDIF file schema/first.ldif to the Directory Server database. See your Directory Server documentation on how to add records in LDIF format.

On your build machine, edit global system configuration file /share/kiki/WF/prod/syscfg. Set the default bind DN (bdn) and password (bpw) to be the DN and password of LDAP server user who has full control over o=NONE subtree (e.g. Directory Manager). Set the LDAP server (server) to be the hostname of the machine on which you installed Directory Server.

Choose a Solaris 2.6 SPARC machine to be your ENGINE machine. If this is different from your build machine, copy the entire directory structure under /share/kiki/WF/prod and /share/Depot/ldapsdk-30-SOLARIS-export-ssl from build machine to the target machine. Go to /share/kiki/WF/prod/engine on the target machine and touch a file log. Make sure that LD_LIBRARY_PATH environment variable in your shell points to /share/Depot/ldapsdk-30-SOLARIS-export-ssl/lib and is exported to children processes.

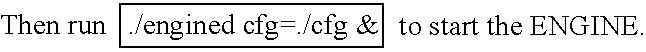

Install and configure a Web server (Netscape Enterprise, Apache, or similar) on a Solaris 2.6 SPARC machine. Install Perl 5.02 on the same machine. Make sure that the Perl 5.02 executable is accessible as /usr/bin/perl. Copy directory structure under /share/kiki/WF/prod from build machine to the Web server machine. Set up a cgi-bin directory for the Web server. Copy Bourne shell scripts from /share/kiki/WF/prod/cgi-bin to the cgi-bin directory and set executable bits on. Start the Web server.

It is now described how to use the system discussed and described above. There are two main uses of our system: developing in-house solutions and using the solutions developed with the help of our system. To illustrate how one would use our system, let us turn to an example. As we mentioned in the Background, in-house solutions may implement business methods or improve operations. Let us focus on an in-house solution that improves internal operations of a business by automating incoming process. An “incoming process” is a process that a company follows whenever a new employee is hired. If a company does not have its incoming process automated, all the steps of the incoming process have to be carried out manually. Consequently, it is costly to hire new employees because of the manual labor involved in the incoming process. Moreover, manual incoming process results in costly delays. Typically, a new employee is unable to perform his or her duties for the first two weeks on the job because of the delays caused by manual incoming process. However, automating the incoming process is also a costly task because of the number of different technologies involved and high complexity of the resulting solution. A typical company will spend one to two years automating the incoming process. Unfortunately, because of rapidly changing environments, an in-house solution that took two years to build will most likely be out of date by the time the company starts using it. We explain below how to automate the incoming process using our system. If one follows our instructions, the automation should only take a few weeks.

A typical incoming process include updating an HR system with employee information, creating an email account for the new employee, issuing an electronic badge for identification and building access, setting up voice mail, ordering equipment, installing software and many other steps. To simply the discussion here, let us assume that the incoming process includes only the first three steps. Thus, we have three APPLICATIONS that need to be updated with information about the new employee: HR system, Email system and Security system. Suppose HR system is located on machine A, Email system is located on machine B and Security system is located on machine C. Let us assume that the hostname of the web server from the previous section is webserver.

Point your BROWSER to http://webserver/cgi-bin/edit_object. Choose to add a New Collection. Give the New Collection an ID of em and choose GO. Give it a name of Employee Management. You will create the rest of your objects in this collection.

For each of the APPLICATIONS, we perform the same four steps. First, create an Agent. Second, install and start an AGENT. Third, write custom executable that updates the APPLICATION. Fourth, create a Job. Because of the similarity, we will only explain how to perform these steps for the first APPLICATION.

Point your BROWSER to http://webserver/cgi-bin/edit_object. Choose to Create New object. Choose to create a new Agent in Employee Management collection with ID of HR_agent. Press Create object Button. On the next page enter Agent name to be HR agent and press Commit Agent Button. A new Agent has been created.

To install AGENT, copy entire directory structures under /share/kiki/WF/prod and /share/Depot/ldapsdk-30-SOLARIS-export-ssl from build machine of previous section to machine A. Go to /share/kiki/WF/prod/agent on machine A and create file log. Also, edit file cfg and set the value of servicedn to be objid=HR_agent, objid=em, objid=Collections, objid=TOP, o=NONE (just like it showed on the Create Agent screen in edit_object). Make sure that LD_LIBRARY_PATH environment variable in your shell points to /share/Depot/ldapsdk-30-SOLARIS-export-ssl/lib and is exported to children processes.

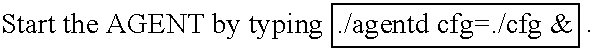

The third step employs knowledge of the HR application and development skills. Write a custom executable (script) that expects four command line arguments. The script should update the HR application with the following information about the new employee: first name, last name, social security number and department. The script should take the data about the new employee from command line arguments. Let us assume that the first argument is employee's first name, the second argument is last name, the third argument is social security number and the fourth argument is department. Place the script in file /scripts/hr_add on machine A and set it's executable bit on. You may wish to test the script to make sure it performs the correct operation.

To create a Job, point your BROWSER to http://webserver/cgi-bin/edit_object. Choose Create New Object. Choose to create a new Job in Employee Management Collection with ID of HR_job and press Create object Button. Set name to be HR Job. Press the Select Agent Button. On the next page, select the HR Agent. Set params to be FirstName, LastName, SSN, Department. Set command to be/scripts/hr_add %<FirstName> %<LastName> %<SSN> %<Department>. Press the Commit Job Button. A new Job has been created.

Now repeat the process for the other two APPLICATIONS. At the end, you should have created three Jobs: HR Job, Email Job and Security job.

Now create ParamW objects for each of the parameters: FirstName, LastName, SSN and Department. To create parameter Fi rstName, point your browser to http://webserver/cgi-bin/edit_object. Select Create New object. Choose to create a new Parameter in Employee Management collection with ID of FirstName and press Create Object Button. Set parameter name to be FirstName and press Commit Object Button. Repeat the process for the other parameters.

The final step is to create a new Action. Point your BROWSER to http://webserver/cgi-bin/edit_object. Choose Create New Object. Choose to create a new Action in Employee Management Collection with ID of new_hire and press Create Object Button. On the next page, set Action Name to be New Hire, insert parameters FirstName, LastName, SSN, Department in the order in which you would like them to appear on the form. Insert the three Jobs you have just created and press Commit Action Button. The development process is over and the new solution is ready to be used.

To use the solution, point your BROWSER to http://webserver/cgi-bin/console. Click on New Hire business process. On the next page, enter the new employee data in each field. For example, enter John in the FirstName field, enter Smith in the LastName field, enter 555-5555 in the SSN field and enter Marketing in the Department field. Press the submit Button. The new employee will be added to HR system, Security system and Email system. You can get updates on the execution of your Request by entering a portion of the Request ID, employees name or submission time on the http://webserver/cgi-bin/console page. This will give you detailed information about execution of the Request and its Job Orders. If there are any errors, they will appear in the Request or Job Order logs and the execution of the Request will be stopped at the first Job Order that fails.

Particular features are now described. First, the web interface for developers and administrators is described. Our web interface for developers and administrators is intuitive and easy-to-use. It presents users with easy-to-understand descriptions of Action and Job definitions aiding in visualization of solution architecture. This description of solution architecture automatically stays up-to-date. Our web interface forces developers to think in terms of high-level modules. It does not clutter display with details of irrelevant components, but allows developers to zoom to a component to get additional details. Our web interface allows administrators to monitor execution of Requests and browse archives of prior Requests and Job Orders. Administrators can easily debug and troubleshoot problems with the help of our web interface.

The automatic USER interface for new solutions is now described. When developers create a solution using our system, it automatically creates USER web interface for the new solution. Thus, developers do not need to be skilled in web interface design or spend their time writing the extra component. USERS benefit from automatic USER interface because every solution created with our system comes with easy-to-use USER interface. Developers get many options allowing them to easily customize USER interface. With our system, developers get the benefits of reusability, since individual USER interface components can be reused from one solution to another. In case USERS need a completely custom USER interface, developers are given the option to externally develop such a USER interface and integrate it into any solution developed with our system. To specify an externally developed USER interface for an Action, simply refer form URL field of the Action to the address of the custom USER interface.

The Network Communications is now described. Our system provides communications between all components of the new solution. Thus, developers do not need to be skilled in network communications or implement network connectivity inside of their components. Therefore the complexity of each individual component is greatly reduced.

Secure communications are also offered. All network communications in our system can be easily switched into secure mode. Secure protocols are very difficult to design and implement because the slightest flaws could invalidate the security of the whole protocol. In order to provide sufficiently high degree of security, secure protocols have to be tested out by a large community over a long period of time. These resources are never available to in-house developers. Lack of skill, time and tests while designing solutions with secure communications often results in low quality security. We use standard secure protocols, LDAPS and HTTPS, for secure communications. These protocols have been created by on-going efforts of many skilled developers and extensively tested by a very large Internet community. Consequently, in-house developers using our system do not need to be skilled in secure communications or spend time and effort on designing secure communications into the solution. To enable secure communications simply configure the web server and LDAP server to work in secure mode. This will automatically switch network protocols from LDAP and HTTP to LDAPS and HTTPS. See FIG. 5 for more details.

Fault detection is provided. Our system provides fault detection at the highest level of component integration. When a fault is detected execution is stopped at the first failing component. Therefore, faulty data is not passed on to the other components. Developers who design their own components do not need to worry how a fault in their component will affect the rest of the solution. Therefore, code for custom components is simplified. The failed component is clearly marked in Request allowing developers and administrators to find the problem quickly.

Logging is also provided, which is particularly useful for debugging problems. Our system logs its own actions and decisions and provides developers with a mechanism to write debugging information to logs. Our system automatically logs all errors and execution details provided by external components and our own software. Logs created during Job Order execution are stored in the Job Order record. Higher level details are stored in Request logs. General problems are logged in ENGINE and AGENT logs. Developers can generate additional debugging information by writing to the standard error stream. Since logs are automatically generated, collected into a central location and displayed over a web interface, developers do not need to design additional logging mechanisms into their components. Thus component code is simplified while administrators and developers are sure to get good debugging information for every solution built with our system.

The components of our system employ a stateless design. ENGINE and AGENTS do not rely on state information stored in memory and store it in LDAPSVR instead. Therefore, ENGINE or AGENT can be restarted without disrupting its normal function. This stateless architecture leads to a more stable system allowing for easy integration with high availability technologies (see below). In addition, state information in LDAPSVR can be examined for debugging purposes.

Our system integrates with high availability technologies. Our system has been designed for easy integration with high availability technologies. ENGINE, AGENTS and CUI do not depend on the LDAPSVR connection to be available at all times or in a continuous fashion. If the connection is lost they will reconnect automatically. Moreover, if administrators specify a list of LDAP servers in the configuration file, ENGINE, AGENTS and CUI will try all servers on the list until they establish connection to one of them. On the other hand, ENGINE and AGENTS themselves can be set up as highly available components. If a failover occurs, the new instance of the component will pick up right where the old one left off because of the stateless design.

The capability to pass “return values” is provided. Developers can pass data generated by their components to other components via Job Order return values (rvals). In order to pass rvals, developers need to specify return parameters in Job definition. Custom executables and APPLICATIONS can pass data to AGENTS by writing return parameter name-value pairs to special RVALS stream as described previously. In Action definition, developers can use reverse parameter mappings to specify where rvals should be stored. ENGINE pulls rvals from complete Job Orders and places them into Request parameters. These parameters can later be passed to other Job Orders.

To allow for greater flexibility and easier code reuse, we provide a parameter substitution feature. It allows Job (or Job Order) parameters to be arbitrary strings with references to Action (or Request) parameters. Parameter substitution is described above.

A background job capability is also provided. Suppose we have an Action with three Jobs and each Job takes 1 hour to execute. If the Jobs are executed in sequence, the whole Action will take three hours to complete. However, if there are no dependencies between Jobs we can run them in parallel. Then the Action would take only one hour to complete. To allow the Jobs to run in parallel, we provide the background Job option. After placing a background Job Order, ENGINE goes on to placing the next Job Order without waiting for the background Job Order to complete. Before marking the whole Request as complete, ENGINE waits for completion of all background Job Orders.

We allow developers and administrators to specify administrator email addresses in Job definitions. If ENGINE encounters a failed Job Order, or if the Job Order takes too long to COMPLETE, ENGINE sends an email notification to the administrator of the Job. This way administrators are automatically notified about problems within their components. Thus, error notification allows for distributed administration, described in greater detail later.

We allow inclusion of configuration files, making it easier to organize configuration information. For example, generic configuration data such as LDAP server and port can be stored in the main configuration file. Configuration files for ENGINE, AGENTS and CUI can then include the main configuration file to get all the generic configuration parameters. For single-valued parameters, our system uses the first value it finds. Therefore if the main configuration file is included at the very end, its default values can be overridden by values specified before the inclusion. For multi-valued parameters our system collects all values specified in all configuration files. Therefore, custom configuration files can add extra values to the ones specified in the main configuration file. We do not impose restrictions on the number or depth of inclusions.

Our system collects all USER data and all execution data in LDAPSVR in searchable format. We provide limited search capabilities in our web interface.

However developers can use our CUI executable get_obj to make more general searches. The executable accepts a general filter parameter that follows the standard LDAP conventions. Developers, administrators and management can gain vital information from reports created using custom searches. These reports can shed light on the use of in-house solutions and give dynamic enterprise statistics.

For security or performance reasons, administrators may wish to run several ENGINES simultaneously. Multiple ENGINES can work with the same LDAP server and post Job Orders to the same AGENTS. However, it is important that the ENGINES service disjoint subtrees. Note that Actions serviced by ENGINE have to be located in its service subtree while Jobs and Agents can be located anywhere in our tree.

Our system allows developers to use two authentication mechanisms: web-based authentication and LDAP-based authentication. No matter what authentication mechanism is used, we make provisions for storing user ID in Request parameters for tracking and use by Job Orders. The first mechanism forces all users of our system to prove their identity to the web server before they can access our system. This mechanism can be initiated by configuring the web server to require authentication before web pages from CGIUI are served to the users. Your web server documentation will explain how to perform such configuration. In this scenario, CGIUI will be passed the user ID by the web server. By default LDAP-based authentication is used. CGIUI queries all users for their user ID and password. CGIUI then attempts to assume the user's identity in communications with the LDAP server. The LDAP server performs authentication and if user ID and password do not match, it will refuse the communication. LDAP users and groups can be created via our admin interface. You should configure the LDAP server to disallow anonymous access. Information on LDAP server configuration can be found in the documentation for your LDAP server.

Many solutions benefit from authentication information. However new authentication methods are difficult to design and require rigorous testing. By providing developers with access to these two authentication mechanisms we eliminate the need for implementation of custom authentication methods for newly created solutions. Thus, development effort and expertise required for creation of solutions with authentication are greatly reduced. As a side comment, developers may choose to use both authentication methods simultaneously forcing user identity tracking in both web and LDAP server logs.

Our system supports two authorization models based on the two authentication methods described above. The first one combines web and LDAP server authorization features while the second one is purely LDAP server based. In the first model, authentication is performed by the web server as described above. Administrator creates several instances of CGIUI with distinct configuration files. Each configuration file specifies an identity to assume when dealing with LDAP server. Web server determines whether a particular user is authorized to access a particular instance of CGIUI. CGIUI then assumes the identity specified in its configuration file. LDAP server determines what kind of operations the identity is authorized to perform with the LDAP Database. To use this authorization model, administrator has to create distinct identities in LDAP server and give them rights (see the documentation for your LDAP server on how to do it). Administrator has to install multiple instances of CGIUI (in separate directories) and specify distinct LDAP server identities in their configuration files. Administrator has to configure the Web server to authorize only specific groups of users to access different CGIUI components (see your Web server documentation for details).

The second model assumes that LDAP-based authentication is used. In this case LDAP server can perform authorization as well. Administrator has to disable anonymous access and set up different rights for different users or groups of users. LDAP server will then automatically perform authorization according to the rules specified by administrator. See you LDAP server documentation for more details.

Many solutions will benefit from built-in authentication and authorization. Thus, we save development time by providing these mechanisms. Moreover, these mechanisms can be used to provide security during the development process itself. Note also, that we can simultaneously have subtrees in LDAPSVR where anonymous access is allowed, subtrees where only authenticated access is allowed but no authorization is performed and subtrees where only authorized access is allowed. Thus, administrators can configure authentication and authorization to closely fit enterprise needs.

When a secure solution is desired, developers may make use of the security features provided by our system: secure communications, authentication and authorization. In addition, our system has been designed with architectural security that developers can further exploit using firewalls and additional configuration. All communications between components of our system happen over LDAP (or LDAPS) and HTTP (or HTTPS) allowing all other network ports to be locked down with firewalls. Moreover, all LDAP connections are opened in the direction of LDAP server (see FIG. 4). Thus, APPLICATION machines that potentially contain important enterprise data (marked A1 through AN in FIG. 4) can be put on secure subnets with no network ports open towards them. Moreover, LDAP server itself can be put onto a secure subnet. If insecure APPLICATIONS need to access LDAP server, only the LDAP (or LDAPS) port needs to be open. Since APPLICATION servers are the ones with vital data, they need to be protected the most. That is why we designed our system so that there is no active party connecting to APPLICATION servers and dictating them what to execute. Instead, our system makes use of AGENTS, which are located on APPLICATION servers. AGENTS pull data from LDAP server and execute code located on APPLICATION servers. In addition, we propose secure AGENT features described later in this Detailed Description. Secure AGENT features ensure that even in case of break-in into LDAP server, intruder still can not dictate APPLICATION servers what to execute. With secure AGENT features, developers will be able to specify command in AGENT configuration file instead of LDAP server. In addition, AGENT will be able to pass parameters to CHILD via standard input stream instead of in command string. This way, the only data AGENT will receive from LDAP server will be parameter values. Thus, intruder can only change parameter values. Since parameter values are no longer part of command string, intruder can not dictate what code AGENT will execute on APPLICATION server.

Our system is designed to enforce a highly modular architecture on the newly created solutions. Specifically, the software is split into separate modules and communication interface between modules is fixed in advance. Each of the modules is self-contained except that it communicates with other modules over the pre-defined interface. Modularity allows software engineers to develop modules in parallel thus shortening the time it takes to complete the whole solution. During the maintenance cycle, any module can be replaced with new code without the need to make modifications to other modules as long as the new module adheres to the old communication interface. Since modularity expedites development and simplifies maintenance of code, software engineers are taught to develop modular code.

Unfortunately, modularity has two drawbacks. First, modularity lengthens design stage requiring to split the code into modules and to define a communication interface. Second, it takes more effort to write modules strictly adhering to the communication interface standard. As discussed in the Background section, in-house development teams are typically focused on short-term benefits. Since most benefits of modularity are realized long term during maintenance cycle, in-house solutions often lack modularity.

Our system pre-defines modular architecture and communication interface thereby shortening the design stage. Since it also provides communications between modules and many other features described in this section, code for each module (component) is greatly simplified. Therefore, our system makes development of modular solutions easier and faster than writing non-modular solutions. Moreover, we build on enforced modularity to deliver even greater benefits to in-house developers and administrators. We discuss later how modularity enforced by our system allows for asynchronous development, distributed administration and component-wise quality assurance.

Besides modularity, the other postulate of software engineering is reusable code. In our system, components of one solution can be naturally reused in other solutions. To reuse a Job, simply refer to it in another Action's script.

Another feature not yet discussed allows for passing standard input to CHILD. To allow AGENT to pass data to CHILD on standard input the following changes need to be made to our source code. Update LDAPSVR schema to define an extra attribute input as case-sensitive string. Update Job and Job Order schema classes to include the extra attribute input. Update Job and Job Order class definitions in util/obj.h, util/Obj.cc, util/Job_Order.h and util/Job_Order.cc to handle the additional field input. Update procedure Req_Builder::build_jo_proto in file util/Req_Builder.cc to copy job.input to jo.input. Update procedure Req_Builder::prep_jo in the same file to replace markers (parameter references) in jo.input. Update procedures Job_Run::build_child_input and Job_Run::init in files agent/Job_Run.cc and agent/Job_Run.h to copy jo.input to child_input. Update package CPAT::Edit::Job of CGIUI (located in perl/CPAT/Edit/Job.pm) to allow developers and administrators to specify value for field input of Job.

To make AGENTS more secure, some embodiments provide the option of specifying command in AGENT'S configuration file rather than in LDAPSVR. To implement this option, the following changes are made to the source code. Define a new configuration parameter secure_Agent_Cmd in file util/WF_const.h. Update procedure Job_Run::init in file agent/Job_Run.cc to check whether a value of Secure_Agent_cmd exists and if so, copy it to command instead of jo.command.

Alternative implementations are now discussed. It is possible to implement our system without AGENTS as shown in FIG. 2. To do this one could utilize remote shell (rsh) for execution of Jobs on remote APPLICATION systems. Remote shell is standard on all UNIX platforms and is available for Windows NT, 95 and 98. If secure communications are desired, secure shell (ssh) can be used in place of ordinary remote shell. In this scenario DEVELOPER, USER and ADMINISTRATOR will interact with UI component. UI component will store information in STORE. ENGINE will pick up information from STORE and remotely execute (via rsh or ssh) Jobs on APPLICATION systems as specified in Action definition. There are two advantages to this alternative implementation. First, it would require less implementation effort on our side. Second, it would be easier to install because in many cases no installation would be required on the APPLICATION systems. There are also two drawbacks to this implementation. First, the resulting system is less stable because ENGINE depends on APPLICATION systems being available for Job execution. Second, the resulting system is less secure because an active remote party (ENGINE) is given the power to execute arbitrary commands on APPLICATION systems that could potentially hold very sensitive data. Considering the above factors, we came to the conclusion that our existing system is superior to this alternative.

While we chose LDAP server as STORE in our implementation, other means could have been used in its place. These include but are not limited to file systems, databases and web servers. We chose LDAP server over these alternatives because it has greater capability to organize and search data than file systems and web servers. On the other hand it is fast and lightweight compared to relational databases. In addition, LDAP servers provide good authentication and authorization mechanisms and a well-tested secure communications protocol (LDAPS). Moreover, transparent referrals make LDAP servers superior compared to databases and allow for sophisticated distribution of data over network and security zones.

Let us point out, that if remote shell mechanism is used instead of AGENTS, file system is used as a STORE and UI component is built into ENGINE, the resulting system would be extremely lightweight and easy to implement. This alternative implementation would consist of a single executable for ENGINE component residing on a single machine and would closely resemble the general system shown in FIG. 1. Despite of the attractive simplicity, we chose our implementation because we believe it delivers more value to in-house solution developers, administrators and users.

Finally, let us note, that our system could have been implemented in languages other than C++. In fact, we wrote the first model of the system in Java, C and C++. We found that C++ delivered better performance than Java and allowed for better code organization and reuse than C. Also we expect that future versions of UI will be partially implemented in JavaScript and Java in addition to Perl and Bourne Shell.

We now discuss how the described embodiments address the issues discussed in the Background. In particular, we introduce two notions: asynchronous development and distributed administration.

While commercial solutions are developed in controlled and synchronized fashion, it is our belief that in-house development is better accommodated by asynchronous development model. First, the initial development team only exists to develop the first version of an in-house solution. The solution later evolves over time as it is modified and extended by other developers. As discussed in the Background, it should not be assumed that developers making extensions to an existing solution participated in its initial development. Second, even initial development team would benefit from asynchronous development model, because with all team members having other responsibilities and priorities synchronization slows the pace of development.

Since in asynchronous development model, it cannot be assumed that communications between developers are possible, pre-defined architecture, modularity and documentation become extremely important. Pre-defined architecture eliminates the need for synchronized design stage in the beginning of development process. It also provides a framework for future development and ensures that resulting solution will be easy to extend. Modularity allows developers to work on their components without affecting other components of solution. Finally, documentation ensures that every developer has a good overall understanding of the solution.

Our system is well suited for asynchronous development, because it pre-defines architecture and enforces modularity. Documentation of the pre-defined architecture will be provided with our system. In addition, high-level description of solution is created by our web interface from Action and Job definitions. Since the description is dynamically created, it stays up-to-date throughout the lifetime of solution.

An integral part of development process is Quality Assurance. If asynchronous development model is to produce quality results, extensions of solution should be thoroughly tested. Enforced modularity of our system allows Quality Assurance engineers (QAs) to take solution apart and test it component by component. This component-wise Quality Assurance shortens the test cycle and narrows required expertise. In addition, QAs benefit from up-to-date documentation and pre-defined architecture. Thus, Quality Assurance will produce much better results with our system than without.

Beyond asynchronous development model, developers using our system benefit from code reuse and built-in features that narrow required expertise and save development effort. Let us note that today all the features provided by our software have to be designed and built by in-house developers in each in-house solution. In our experience, these features account for eighty to ninety percent of code for each in-house solution. Since with our software developers only need to perform ten to twenty percent of the work, our software dramatically increases efficiency of in-house development. Moreover, since our software will enjoy the benefits of high exposure to technical audience, eighty to ninety percent of each in-house solution built with our system will receive these benefits as well. Therefore, our system increases quality and reliability of in-house solutions. In addition, we provide in-house developers with an array of security options including secure communications, secure architecture, authentication and authorization mechanisms.

We now discuss the concept of “distributed administration” to support in-house solutions. As we discussed in the Background portion, support of in-house solutions is performed by administrators on demand. Thus, in-house support enjoys even less control and synchronization than in-house development. Moreover, due to complexity of in-house solutions, it is difficult to find administrators with all required expertise. Based on these observations, we propose a distributed administration model. In this model, we do not assume that administrators are proactive, knowledgeable about the whole solution or work as a team to resolve problems. Instead, our system monitors execution, detects faults and notifies the right person when problems arise. Thus, distributed administration ensures that problems are detected and debugged quickly. In our system, distributed administration is made possible by enforced modularity, fault detection and error notification. Pre-defined architecture and up-to-date documentation allow administrators to gain overall knowledge of solution. Beyond the overall understanding, an administrator only needs to have narrow in-depth knowledge of the one component he supports, because of distributed administration. Thus, administrators are far less likely to introduce new problems by patches to existing in-house solutions. In addition, administrators can use our web interface to disconnect faulty components from an in-house solution with a few clicks of the mouse allowing the rest of the solution to function immediately.

### CONCLUSION

To summarize, our invention enables enterprises to efficiently build and maintain high-quality in-house solutions that are secure and reliable, and that dynamically adjust to enterprise's needs.

What is claimed is:

1. A system to coordinate the execution of a plurality of separate target computer systems to effectuate a process, the system comprising:
(a) a core system for receiving a request by a user to effectuate the process, the request including user data upon which it is desired to effectuate the process and an indication of an action corresponding to the process; and
(b) the core system further including a centralized execution controller that controls and coordinates execution of the target computer systems based on the user data and execution rules corresponding to the indicated action, thereby accomplishing effectuation of the process.

2. The system of claim 1, wherein:
(a) the target computer systems do not communicate with each other about the execution thereof.

3. The system of claim 1, wherein:
(a) the core system includes an authenticator that authenticates the user and determines, based on the authentication, whether the user is authorized for the process; and
(b) the execution controller operates in part based on the authorization determination.

4. The system of claim 1, wherein:
(a) the system further comprises:
(i) a monitor that monitors execution of the target computer systems and logs monitoring results thereof; and
(ii) a log processor that processes the monitoring results based on a query from the user.

5. The system of claim 1, wherein:
(a) the core system includes a memory that holds, in a non-volatile manner, a state of execution of the target computer systems; and
(b) the core system operates based on the state of execution stored in the memory.

6. The system of claim 1, and further comprising:
(a) a configurator that receives indications of process definition information from a developer and provides the execution rules based on the process definition information.

7. The system of claim 6, wherein:
(a) the configurator displays to the developer a plurality of possible indications of the process definition information; and
(b) at least some of the indications received by the configurator from the developer are a subset of the plurality of possible indications displayed by the configurator.

8. The system of claim 6, wherein:
(a) the configurator includes means for creating a user interface and relating the execution rules to the user interface; and
(b) the core system operates at least in part based on interaction by the user with the user interface.

9. The system of claim 8, wherein:
(a) the user interface is a first user interface; and
(b) the configurator includes means for creating a second user interface based on at least a portion of the first user interface.

10. The system of claim 6, wherein:
(a) the process is a first process; and
(b) the configurator includes means for providing at least some of the execution rules, for effectuating the first process, to effectuate the second process.

11. The system of claim 1, wherein the core system includes:
(a) a data store that stores the execution rules; and
(b) an engine that operates on the stored execution rules to effectuate the process.

12. The system of claim 11, wherein:
(a) the data store further stores an indication of a state of execution of the target computers; and
(b) the engine further operates on the stored execution state.

13. The system of claim 1, wherein:
(a) the centralized execution controller comprises agent means, executing on the target computer systems, for causing the target computer systems to execute based on the execution rules to effectuate the process.

14. The system of claim 13, wherein:
(a) the agent means includes monitoring means for monitoring the execution of the target computer systems and for generating monitoring results thereof; and
(b) the engine means operates at least in part based on the monitoring results.

15. The system of claim 13, wherein:
(a) at least one of the target computer systems executes an operating system; and
(b) the agent means executing on that target computer system controls execution of the target computer system by making at least one system call to the operating system.

16. The system of claim 1, wherein:
(a) the core system includes a plurality of components; and
(b) the system further comprises a data store via which the components of the core system communicate.

17. The system of claim 16, wherein:
(a) the core system includes a component that is a user interface for interaction with at least one user; and
(b) the user interface stores data into the data store based on actions of the user for communication with other components of the core system.

18. The system of claim 17, wherein the user interface further retrieves data from the data store for communicating the information to the user.

19. The system of claim 1, wherein:
(a) the core system operates based on data objects; and
(b) the system further comprises means for creating new data objects based on old data objects, whereby the old data objects are reusable.

20. The system of claim 19, wherein:
(a) the data objects include jobs and job orders;
(b) the core system operates on the job orders; and
(c) the system includes means for creating the job orders based on the jobs.

21. The system of claim 20, wherein:
(a) the data objects include actions;
(b) the actions are comprised of the jobs.

22. The system of claim 21, wherein:
(a) the actions are further comprised of user interface component templates;
(b) the data objects include user interface component templates; and
(c) the core system interacts with the user based at least in part on the user interface component templates.

23. The system of claim 19, wherein:
(a) the data objects include actions and requests;
(b) the core system operates on the requests; and
(c) the system includes means for creating the requests based on the actions.

24. The system of claim 19, wherein:
(a) the data objects include user interface component templates; and
(b) the core system interacts with the user based at least in part on the user interface component templates.

25. A system to coordinate the execution of a plurality of separate target computer systems to effectuate a process, the system comprising:
(a) user interface means for receiving a request by a user to effectuate the process, the request including user data upon which it is desired to effectuate the process and an indication of an action corresponding to the process;
(b) engine means for generating a series of job orders based on the user data and execution rules corresponding to the indicated action; and
(c) agent means for causing execution of the target computer systems based on the job orders, thereby accomplishing effectuation of the process.

26. The system of claim 25, wherein:
(a) the execution rules include target computer system dependent commands; and
(b) the engine modifies the target computer dependent commands based on the user-supplied data and provides the modified target computer dependent commands to the agents so that the target computer systems accomplish the effectuation of the business process in a specific manner corresponding to the user-supplied data.

27. The system of claim 26, wherein:
(a) the modified target computer dependent commands are part of the job orders.

28. The system of claim 26, wherein:
(a) the job orders include pointers to the modified target computer dependent commands.

29. The system of claim 25, and further including:
(a) storage means for storing the actions and requests.

30. The system of claim 25, and further including:
(a) storage means for storing the generated execution results and from which the generated execution results are accessible to the engine means.

31. The system of claim 29, wherein the storage means is a directory server.

32. The system of claim 25, and further comprising:
(a) storage means for storing the request provided by the user.

33. The system of claim 32, wherein:
(a) the storage means is coupled to the engine means for storing the series of job orders; and
(b) the storage means is further coupled to the agent means for providing the job orders to the agent means.

34. The system of claim 25, wherein:
(a) each action has corresponding to it:
(i) an input means into which requests from a user are stored before being provided to the engine means;
(ii) a job order storage means into which the job orders are stored; and
(iii) an output means into which status indicators are stored after attempted effectuation of the business process.

35. The system of claim 34, wherein:
(a) the engine means includes:
(i) means for receiving the request from the input means corresponding to the action;
(ii) means for processing the request received from the input means to generate the job orders; and
(iii) means for providing the generated job orders to the job order storage means; and
(b) the agent means includes means for receiving the generated job orders from the job order storage means.
